(19) United States
(12) Patent Application Publication
(10) Pub. No.: US 2004/0018048 A1
(43) Pub. Date: Jan. 29, 2004

(54) Pneumatic docking system

(76) Inventor: Earl W. Sausen, Gilroy, CA (US)

Correspondence Address: Robert Charles Hill, 235 Montgomery Street #821, San Francisco, CA, 94104, US

(21) Appl. No.: 10/206,454

(22) Filed: Jul. 26, 2002

(51) Int. Cl. B25G 3/00

(52) U.S. Cl. 403/316

(57) ABSTRACT

A pneumatic docking system comprises a knobbed pin that is mounted to one half of a semiconductor device test and handling module, and a docking cylinder that can be actuated to receive and lock in the knobbed pin. The docking cylinder is mounted to the other half of the semiconductor device test and handling module, and its locking action brings both halves into tight and secure alignment with one another. Inside the docking cylinder, there is a pneumatic piston connected to three petal sections that open out and separate to receive the knobbed pin. The piston is pushed back and forth inside the cylinder according to air pressure supplied to two different supply ports. The airflow can be controlled to adjust the speed and overall force at which docking or undocking proceeds Several such cylinders are arranged in a test head positioning assembly to provide a precise and reliable hard-dock mechanism for final test and wafer sorting.

### BACKGROUND OF THE INVENTION

1. Field of the Invention

The present invention relates to mechanical locks and docking mechanisms, and more particularly to devices that can mechanically align and draw together test heads and devices-under-test in automatic test equipment.

2. Description of Related Art

Semiconductor bare chips and packaged devices need to be tested after manufacturing for various reasons before being put to final use. Chip manufacturers want to verify the products are functional. Systems manufacturers want to see that the components they receive are not dead-on-arrival (DOA) and that the parts will perform properly in the expected environments.

As a result, the automated test equipment (ATE) industry has produced and marketed systems that can electrically connect to and probe the device-under-test (DUT). Such DUT's tend to be very small and have a large number of contacts or pins that must be reliably connected to. Testing can involve hundreds and even thousands of DUT's and each cycle must make sure and confident contact with all the pins and contacts needed to be probed.

A typical ATE system has one or more test sockets into which the DUT's are placed. Then a test head is brought down and closed over it, e.g., like a clamshell. The alignment of the mechanical pieces is critical because the pin-to-pin spacing pitch is so tiny.

Rajiv Mehta, et al., describe the TESTING OF BGA AND OTHER CSP PACKAGES USING PROBING TECHNIQUES in U.S. Pat. 6,404,212 B1, issued Jun. 11, 2002. Such Patent discusses the general issues involved with ATE systems and their application to the testing of ball grid array (BGA) devices in particular.

### SUMMARY OF THE INVENTION

Briefly, a pneumatic docking system embodiment of the present invention comprises a knobbed pin that is mounted to one half of a semiconductor device test and handling module, and a docking cylinder that can be actuated to receive and lock in the knobbed pin. The docking cylinder is mounted to the other half of the semiconductor device test and handling module, and its locking action brings both halves into tight and secure alignment with one another. Inside the docking cylinder, there is a pneumatic piston connected to three petal sections that open out and separate to receive the knobbed pin. The piston is pushed back and forth inside the cylinder according to air pressure supplied to two different supply ports. The airflow can be controlled to adjust the speed at which docking or undocking proceeds. Several such cylinders are arranged in a test head positioning assembly to provide a precise and reliable hard-dock mechanism for final test and wafer sorting.

An advantage of the present invention is that a docking mechanism is provided that can draw parts of a test head together.

Another advantage of the present invention is that a docking mechanism is provided with multiple connection points that for safety all must be properly aligned and engaged before the whole can be drawn together.

A further advantage of the present invention is that docking mechanism is provided that can operate properly even when its two parts begin slightly out of alignment.

A still further advantage of the present invention is that a docking system is provided that can repeatably bring two assemblies together at three point to maintain a precise separation and parallelism.

Another advantage of the present invention is that a docking mechanism is provided that can be force controlled with the compressed air that is applied to all cylinders in parallel.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a perspective view of a pneumatic docking system embodiment of the present invention shown in its open and unlocked position where a device-under-test may be loaded and unloaded;

FIG. 2A is a perspective, exploded assembly view of a pneumatic docking cylinder embodiment of the present invention similar to that of FIG. 1, and shows the parts that are assembled inside a cylinder wall;

FIG. 2B is a perspective view of the pneumatic docking cylinder of FIG. 2A in which the three capture arms have been grouped together on a piston stem, such shows the capture arms rotated open to receive a knobbed pin;

FIG. 2C is a perspective view of the pneumatic docking cylinder of FIGS. 2A and 2B in which the three capture arms on the piston stem have closed and locked around the knobbed pin; and

FIG. 3 is a perspective, exploded assembly diagram of a semiconductor device test and handling module system embodiment of the present invention.

### DETAILED DESCRIPTION OF THE INVENTION

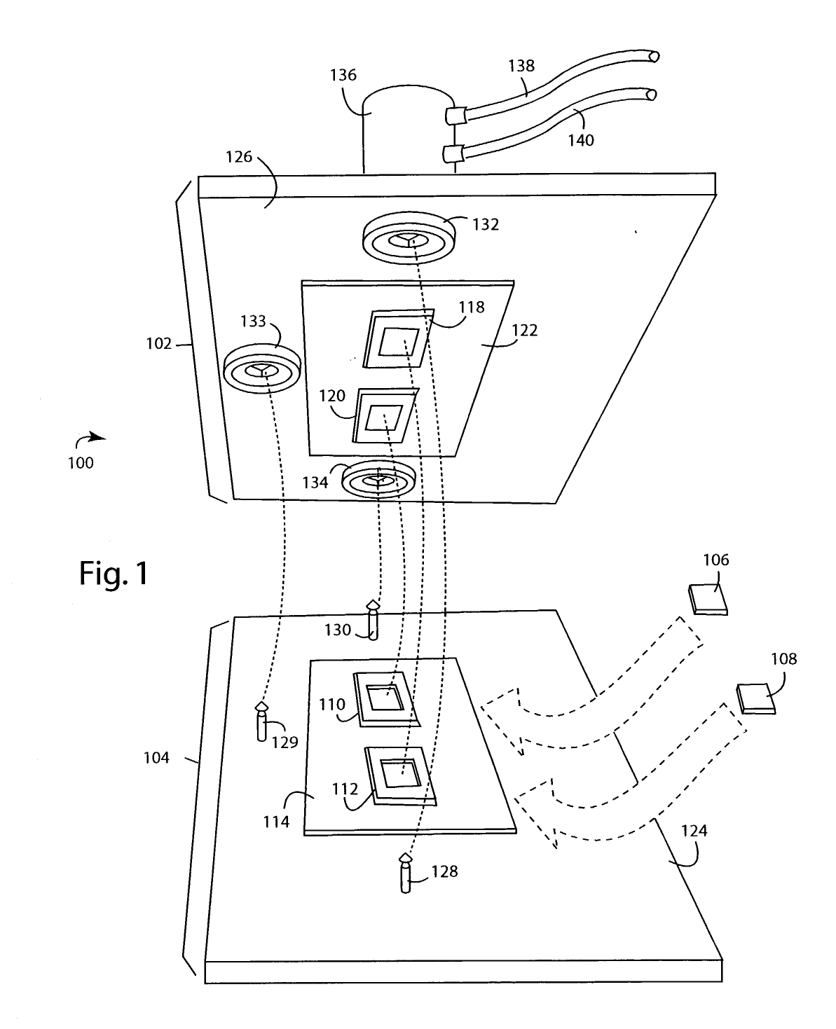

FIG. 1 illustrates pneumatic docking system embodiment of the present invention, and is referred to herein by the general reference numeral 100. In a semiconductor device test and handling module application, the system 100 comprises a test head assembly 102 and matching handler assembly 104. One or more device-under-test (DUT) units 106 and 108 are fit into a pair of test sockets 110 and 112 when the module is opened to receive them. The DUT's are introduced from underneath an interface signal contact plane 114. Such test sockets provide mechanical support to the DUT's 106 and 108 promote good interface-signal-contact with a pair of test-socket caps 118 and 120 on a DUT printed circuit board (PCB) 122. The device signal paths are ultimately carried out to the test head assembly 102. A bottom plate 124 provides a base for handler assembly 104. The DUT PCB 122 is preferably mounted solidly to a top plate 126 which is a foundational part of the test head assembly 102.

A docking assembly comprising three individual docking mechanisms is used to release, capture, and align top and bottom plates 124 and 126 together. The pressure and alignment of test-socket caps 118 and 120 on DUT's 106 and 108 in test sockets 110 and 112 depends on how well this docking assembly works. In some embodiments of the present invention, all three individual docking mechanisms are interlocked so that none will draw down if any one is not prepositioned properly and can eventually lock. In still further embodiments of the present invention, all three individual docking mechanisms are supplied in parallel by the same compressed air supply system that is pressure regulated to control the overall forces applied in the docking operations.

Each of the individual docking mechanisms comprises a knobbed pin 128-130 that is respectively captured and released by a pneumatic docking cylinder 132-134. Given the perspective of FIG. 1, only pneumatic docking cylinder 132 can be seen to have a cylinder body 136. Inside, a piston operates under air pressure applied alternately to air-supply lines 138 and 140.

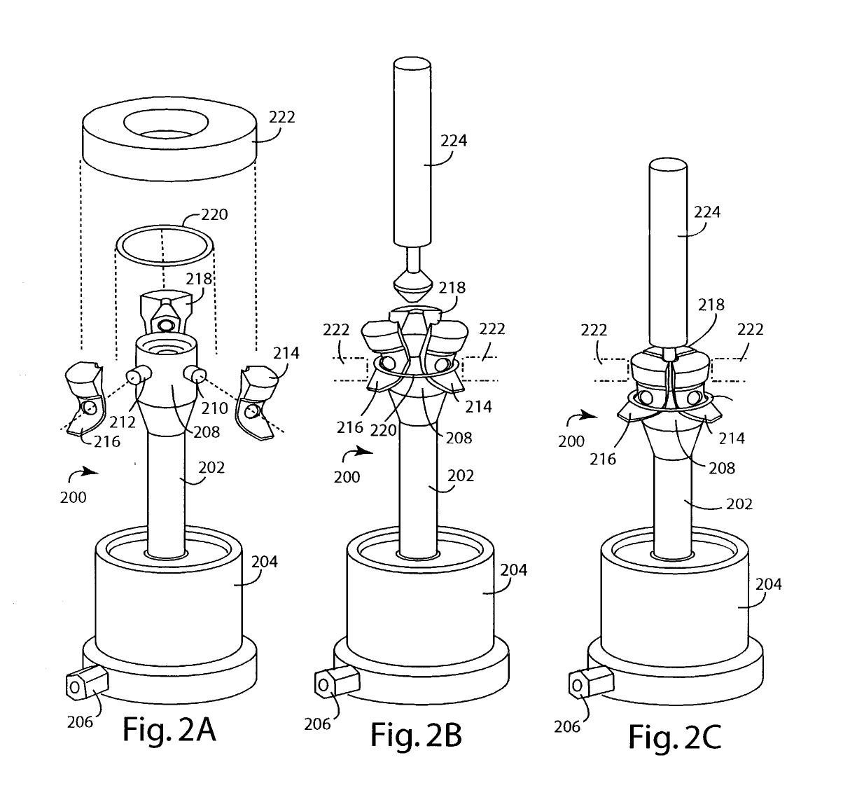

In typical applications, the separation distance and planar parallelism between the lower and upper plates 124 and 126 is critical. The two must repeatably lock together at the knobbed pins 128-130 and pneumatic docking cylinders 132-134, e.g., within 0.005 inches of ideal. Therefore, some embodiments of the present invention use a slip collar mounted to upper plate 126 to adjust the individual heights of pneumatic docking cylinders 132-134. Such is illustrated in more detail in FIGS. 2A-2C.

FIG. 2A represents a pneumatic docking cylinder embodiment of the present invention similar to that of FIG. 1, and is referred to herein by the general reference numeral 200. A piston stem 202 is attached to a piston that moves up and down under air pressure inside a piston sleeve 204. An air fitting 206 channels one side of the air pressure to the underside of such piston to push it up into the position shown in FIG. 2A. A hub 208 has three radial pins, represented by pins 210 and 212 on which are hung three capture arms 214, 216, and 218. The distal end of hub 208 is cupped to precisely fit a coned end of a knobbed pin, e.g., as in FIGS. 2B and 2C. An elastic band 220 slips over around the three capture arms 214, 216, and 218, and keeps them on the hub 208 during manufacturing assembly.

The whole is housed inside a body cylinder (not shown) that has a second air fitting. Pressure inside such body cylinder finds its way into the top of piston sleeve 204 and operates to push the piston stem 202 back down, as in FIG. 2C. In one embodiment, a capture-arm ring 222 slips over the capture arms 214, 216, and 218. It forces them to petal outward to receive a knobbed pin 224, as in FIG. 2B, and close and lock together as in FIG. 2C when piston stem 202 pulls back. The capture-arm ring 222 is represented in FIGS. 2B and 2C by a dotted line only to better show the other details. Other methods can be used to the same ends.

FIG. 2B shows the pneumatic docking cylinder 200 with the capture arms 214, 216, and 218, assembled onto the end of hub 208 and retained during manufacture by elastic band 220. The capture-arm ring 222 is shown in dotted form low down around the flared ears on the bottoms of capture arms 214, 216, and 218. When piston stem 202 pushes out, the capture arms 214, 216, and 218, are forced through the top of capture-arm ring 222 and each twist out like a flower's petals to open up to receive the knobbed pin 224.

Such knobbed pin 224 is mounted to one mechanical assembly that needs to be drawn in and positioned relative to the mechanical assembly the docking cylinder 200 is mounted to. The combination of the machined cupped end of hub 208 and the machined coned end of knobbed pin 224 operates to bring at least one set of adjacent points on the two mechanical assemblies into three-dimensional alignment. Three such sets of adjacent points on the two mechanical assemblies can be used, as in FIG. 1, to effectuate a precise plane-to-plane alignment.

FIG. 2C represents the condition when the knobbed pin 224 has been captured and drawn down by piston stem 202. The tops of capture arms 214, 216, and 218, are constricted down into the top of capture-arm ring 222 and close tight around the distal end of knobbed pin 224. Preferably, there is zero mechanical lash in this state, so as to keep the relative positions of the two planes to within 0.005 inches.

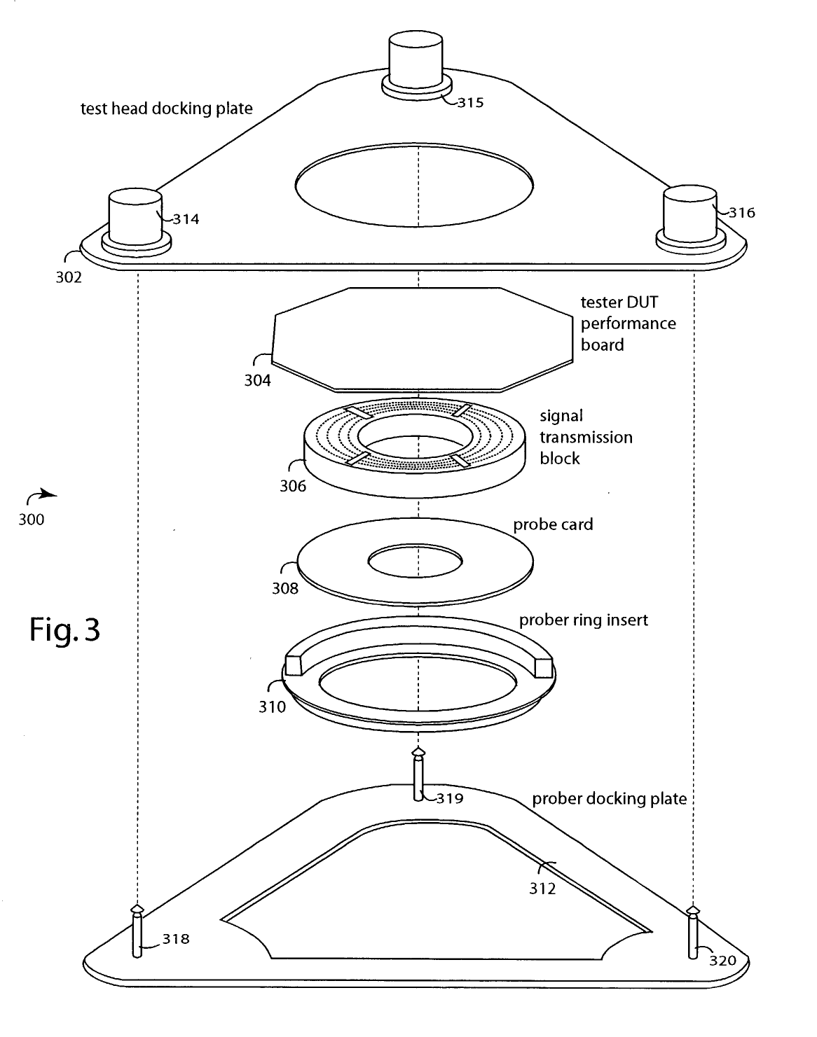

FIG. 3 illustrates another pneumatic docking system embodiment of the present invention, a semiconductor device test and handling module system that is referred to herein by the general reference numeral 300. The system 300 comprises a test head docking plate 302, a tester DUT performance board 304, a signal transmission block 306, a probe card 308, a prober ring insert 310 and a prober docking plate 312. A set of three pneumatic docking cylinders 314-316 are connected in parallel to a compressed air supply. Such compressed air is valved and regulated to allow the pneumatic docking cylinders 314-316 to draw-down, lock, and unlock on a set of matching docking pins 318-320 with variable force.

Embodiments of the present invention are not limited to ATE and other electronics applications, purely mechanical system can benefit as well. Such embodiments are useful anywhere that one mechanical assembly needs to dock, lock, unlock, and disengage with another. A significant characteristic of the embodiments disclosed here are their ability to reach out in a modest way and draw back in the knobbed docking pins to a repeatable, final lockdown position. Such draw back is possible even when there exists minor alignment differences in the two docking parts just before and during capture.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is

1. A pneumatic docking system, comprising:
a pin with a knob on a distal end and a near end for mounting to a first mechanical assembly;
a docking cylinder for mounting to a second mechanical assembly and providing for a reaching out and capturing of the pin at said knob, and further providing for the pin to be drawn back in;
wherein, said first mechanical assembly and said second mechanical assembly can be repeatably engaged and disengaged, and while engaged maintained in a constant relative position.

2. The system of claim 1, wherein the docking cylinder further comprises:
a pneumatic piston assembly;
a piston stem attached to the pneumatic piston assembly and providing for an up and down motion under the influence of an air supply;
a hub disposed on a distal end of the piston stem and having a cupped area to receive the pin; and
a set of three capture arms disposed about the hub and providing for engaging and disengaging said knob on said distal end of the pin according to the longitudinal position of the piston stem.

3. The system of claim 2, wherein the docking cylinder further comprises:
a collar in which the set of three capture arms are disposed and allowed to rock on the hub, and providing for engaging and disengaging said knob on said distal end of the pin according to the longitudinal position of the piston stem.

4. A pneumatic docking system, comprising:
a set of three pins each with a knob on a distal end and a near end for mounting to three points that define a first plane for a first mechanical assembly;
a set of three docking cylinders for mounting to three corresponding points that define a second plane for a second mechanical assembly and providing for a reaching out and capturing of the pin at said knob, and further providing for the pin to be drawn back in;
wherein, said first mechanical assembly and said second mechanical assembly can be repeatably engaged and disengaged, and while engaged maintained in a constant relative position and compressive force between said first and second planes.
